(19) United States
(12) Patent Application Publication
(10) Pub. No.: US 2008/0024657 A1
(43) Pub. Date: Jan. 31, 2008

(54) Pulldown-sequence detecting device, method of detecting pulldown sequence, and computer program product

(75) Inventors: Hideki Matsuoka, Kawasaki (JP); Mari Iwasaki, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/788,685

(22) Filed: Apr. 20, 2007

(30) Foreign Application Priority Data
Jul. 31, 2006 (JP) 2006-209173

(51) Int. Cl. H04N 11/20

(52) U.S. Cl. 348/448; 348/E11.021

(57) ABSTRACT

A pulldown-sequence detecting device includes a determining unit that performs motion determination on every pixel by comparing a field of an interlace image input into the device with a field of the preceding frame stored in a field memory, a calculating unit that calculates a difference between the features of the portions determined as having some movement by the determining unit and the corresponding portions of the immediately preceding field stored in another field memory, and a detecting unit that detects a pulldown sequence on the basis of the variation pattern of the inter-field feature differences calculated by the calculating unit.

### BACKGROUND OF THE INVENTION

1. Field of the Invention

The present invention relates to a pulldown-sequence detecting device and a method of detecting a pulldown sequence from an interlace image.

2. Description of the Related Art

Recently, liquid crystal displays and plasma displays, or so-called flat panel displays, are being widely used as displaying means in television receivers instead of cathode ray tubes. The flat panel displays are advantageous in that they are thinner and they can display images with less flickers because they employ the technology of progressive scanning.

In the progressive scanning, all the lines (scan lines) in a frame are sequentially scanned. On the other hand, in the technique called interlace scanning, only alternate lines in a frame are scanned so that the amount of information necessary to transmit an image reduces to half. Due to this reason, even today the interlace scanning is being widely used for television broadcasting and the like.

Most of the television receivers with a flat panel display are provided with a function called interlace-to-progressive (IP) conversion. Each of the fields of the interlace image contains information on either odd numbered lines or even numbered lines. With the IP conversion function, information corresponding to the counterpart lines is interpolated so that one complete frame can be produced from a single field only. The IP conversion function enables, for example, a progressive image to be produced at a rate of 60 frames per second out of an interlace image provided at a rate of 60 fields per second thereby improving the image quality.

The interlace image can be classified into two types: an image photographed originally by interlace scanning, and an image converted to interlace image from a progressive image or a film image (hereinafter, “progressive image etc.”). For instance, an image photographed originally by interlace scanning at a rate of 60 fields per second consists of fields that are different from one another for every 1/60 second.

On the other hand, if a 60-field-per-second interlace image is produced by dividing frames of a 30-frame-per-second progressive image such as a commercial film into odd line fields and even line fields, every two fields are images of the same moment.

Because the image photographed originally by interlace scanning and the image converted from the progressive image etc. are different in the relationship of fields in terms of time, different interpolation processes are required for their IP conversion. A technique of detecting whether the interlace image is the one that is converted from the progressive image etc. is called pulldown sequence detection. The accuracy of the pulldown sequence detection plays a key role in the quality of the image produced after the IP conversion.

In general, two fields generated from the same frame exhibit features that are analogous to each other, while two fields generated from different frames exhibit features that are considerably different. Thus, an image converted from a progressive image etc. shows a specific variation pattern in differences in the features of every two fields, changing from small to large, to small, to large, and so on. The conventional pulldown sequence detecting technology has been based on this characteristic to realize pulldown sequence detection. A conventional art has been disclosed, for instance, in International Publication WO 2000/16561.

However, according to the conventional pulldown detecting method, if an image significantly changes in brightness or is a high-definition live-action image, the variation pattern of the features of the fields may coincide with the variation pattern of an image converted from a progressive image etc. This leads to erroneous detection of a pulldown sequence. Furthermore, if an image includes a subtle motion of a subject, a pulldown sequence may not be detected at all.

### SUMMARY OF THE INVENTION

It is an object of the present invention to at least partially solve the problems in the conventional technology.

According to an aspect of the present invention, a pulldown-sequence detecting device that detects a pulldown sequence from an interlace image includes a determining unit that compares a first field included in the interlace image with a third field of an immediately preceding frame and thereby performs motion determination on every pixel; a calculating unit that calculates an absolute value of a difference between features by using a portion of the first field that is determined by the determining unit as having movement and peripheral pixels of a second field that is a field immediately preceding the first field; and a detecting unit that detects a pulldown sequence in accordance with a variation pattern of the absolute value of the difference between the features of the fields calculated by the calculating unit.

According to another aspect of the present invention, a method of detecting a pulldown sequence from an interlace image includes determining whether there is motion in each pixel by comparing a first field included in the interlace image with a third field of an immediately preceding frame; calculating an absolute value of a difference between features by using a portion of the first field that is determined at the determining as having movement and peripheral pixels of a second field that is a field immediately preceding the first field; and detecting a pulldown sequence in accordance with a variation pattern of the absolute value of the difference between the features of the fields that are calculated at the calculating.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a pulldown-sequence detecting method according to an embodiment of the present invention;

FIG. 2 is a functional block diagram of a pulldown-sequence detecting device according to the embodiment;

FIG. 3 is a schematic for explaining structure of data stored in a variation-pattern storage unit shown in FIG. 2;

FIG. 4 is a flowchart of the processing procedure performed by the pulldown-sequence detecting device;

FIG. 5 is a functional block diagram of a computer that executes a pulldown-sequence detecting program to realize the pulldown-sequence detecting method;

FIG. 6 is a schematic for explaining a conventional pulldown-sequence detecting method; and

FIG. 7 is a functional block diagram of a conventional pulldown-sequence detecting device.

### DETAILED DESCRIPTION OF THE PREFERRED EMBODIMENTS

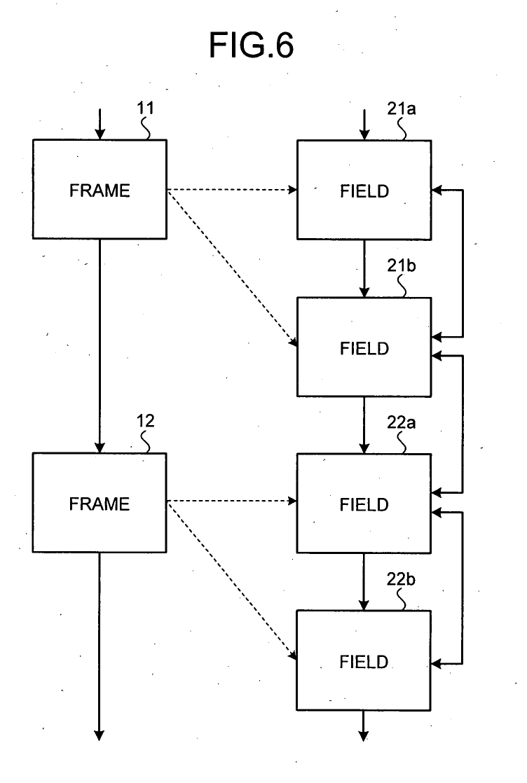

Exemplary embodiments of the pulldown-sequence detecting device and the pulldown-sequence detecting method according to the present invention will be explained in detail below, with reference to the attached drawings. In the following embodiments, 2:2 pulldown sequence detection will be used as an example of pulldown sequence detection. However, the present invention is applicable to any pulldown sequence detection. First, a conventional pulldown-sequence detecting method will be explained below. FIG. 6 is a schematic of the conventional pulldown-sequence detecting method.

In conversion of a progressive image to an interlace image, a field 21a is generated from odd numbered lines of a frame 11, and a field 21b is generated from even numbered lines of the frame 11. Then, a field 22a is generated from odd numbered lines of a frame 12 that comes after the frame 11, and a field 22b is generated from even numbered lines of the frame 12.

Let us compare the fields of the converted interlace image with adjacent ones. With regard to the fields 21a and 21b, the former is a field composed of the odd numbered lines of the frame 11, while the latter is a field composed of the even numbered lines of the frame 11. This means that the fields 21a and 21b are generated from the same frame, and although in terms of space, the images are shifted from each other by one line, they represent the same timing.

With regard to the fields 21b and 22a, the former is a field composed of the even numbered lines of the frame 11, while the latter is a field composed of the odd numbered lines of the frame 12. In other words, the fields 21b and 22a are generated from different frames. In terms of space, the images are shifted from each other by one line, and in terms of time also, they represent different timings.

With regard to the fields 22a and 22b, the former is a field composed of the odd numbered lines of the frame 12, while the latter is a field composed of the even numbered lines of the frame 12. It means that the fields 22a and 22b are generated from the same frame, and although in terms of space, the images are shifted from each other by one line, they represent the same timing.

By comparing any two adjacent fields of a converted interlace image in this fashion, it can be seen that a pair of fields generated from the same frame and representing the same timing and a pair of fields generated from different frames and representing different timings alternately appear. In other words, the fields generated from the same frame and representing the same timing are highly analogous to each other, while the fields generated from different frames and representing different timings are less analogous to each other.

Thus, in an interlace image converted from a progressive image etc., pairs of fields relatively analogous to each other and pairs of fields relatively less analogous to each other alternately appear. With the conventional pulldown-sequence detecting method, a pulldown sequence is detected by analyzing the analogy variation pattern of pairs of adjacent fields.

For instance, an interlace image converted from a progressive image etc. with a method of generating two fields from every frame as indicated by an example of FIG. 6 can be detected by monitoring the variation in the features that show levels of differences in pairs of adjacent fields and finding a low-high-low-high variation pattern.

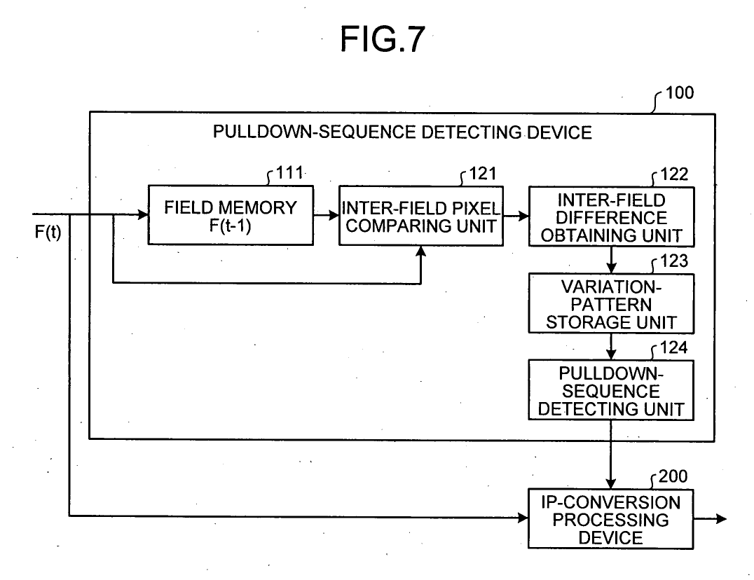

Next, a conventional pulldown-sequence detecting device will be explained below. FIG. 7 is a functional block diagram of a conventional pulldown-sequence detecting device 100. The pulldown-sequence detecting device 100 includes a field memory 111, an inter-field pixel comparing unit 121, an inter-field difference obtaining unit 122, a variation-pattern storage unit 123, and a pulldown-sequence detecting unit 124.

The field memory 111 stores therein the last field of an interlace image input into the pulldown-sequence detecting device 100. If the image data currently input into the pulldown-sequence detecting device 100 is a field F(t), the field memory 111 stores the preceding field F(t-1).

The inter-field pixel comparing unit 121 compares the pixels of the field currently input into the pulldown-sequence detecting device 100 and the pixels of the preceding field that is stored in the field memory 111, and outputs the result of the comparison to the inter-field difference obtaining unit 122. The inter-field pixel comparing unit 121 compares the image data pixel by pixel.

The comparison of pixels can include, for example, comparison of brightness values of the pixels. Moreover, the comparison of target pixels can be conducted in one to one basis, or can be conducted by considering values of pixels around the target pixels. In the following explanation, it is assumed that the inter-field pixel comparing unit 121 compares the brightness of individual pixels of the same positions and outputs the differences in brightness to the inter-field difference obtaining unit 122.

The inter-field difference obtaining unit 122 obtains a difference between the features of the currently input field and the preceding field stored in the field memory 111, based on the value input from the inter-field pixel comparing unit 121. The difference between the features of the fields can be obtained, for example, by calculating the sum of absolute difference (SAD) in the brightness of individual pixels.

The variation-pattern storage unit 123 is a storage unit that stores the predetermined number of differences most recently calculated by the inter-field difference obtaining unit 122. The variation-pattern storage unit 123 can be configured to store therein the values calculated by the inter-field difference obtaining unit 122 as they are, or values that indicate the comparative relation of the values obtained by the inter-field difference obtaining unit 122 with a predetermined threshold.

The pulldown-sequence detecting unit 124 monitors the variation pattern of the values stored in the variation-pattern storage unit 123 and, when a certain variation pattern appears, notifies an IP-conversion processing device 200, which performs IP conversion, that a pulldown sequence is detected.

The IP-conversion processing device 200 is a processing unit that performs a suitable complementing process in accordance with the notification from the pulldown-sequence detecting unit 124 or the like to convert the interlace image to a high-quality progressive image.

According to the conventional pulldown-sequence detecting method, a pulldown sequence is detected on the basis of the variation pattern of the difference levels between the fields. The conventional pulldown-sequence detecting method, however, may fail to detect a pulldown sequence if an interlace image converted from a progressive image etc. does not exhibit a significant difference between the fields if very little motion is involved in the progressive image etc. before the conversion.

In addition, even if an interlace image is not converted from a progressive image, when the interlace image includes significant changes in brightness, a pulldown sequence may be erroneously detected because the differences between the fields happen to show a low-high-low-high pattern.

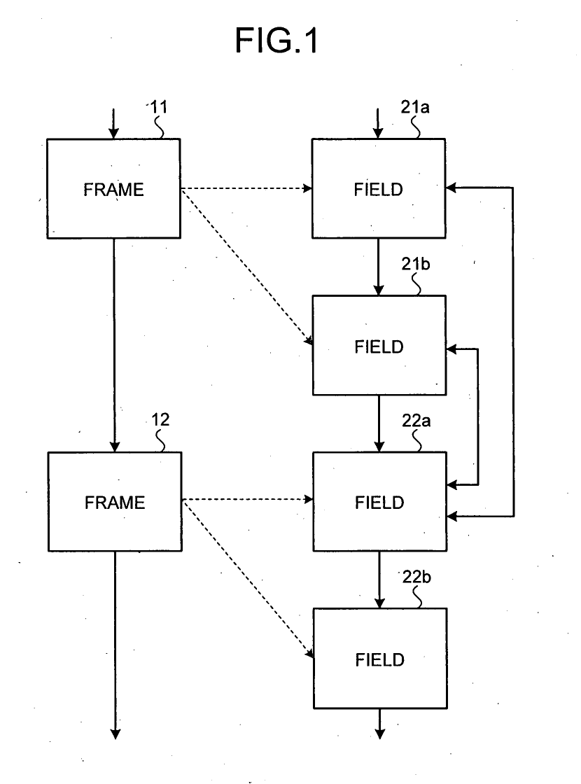

The overview of a pulldown-sequence detecting method according to an embodiment of the present invention will be explained next. FIG. 1 is a schematic for explaining the pulldown-sequence detecting method according to the embodiment.

In the same manner as FIG. 6, it is assumed that the field 21a is generated from the odd numbered lines of the frame 11, and the field 21b is generated from the even numbered lines of the frame 11 when converting a progressive image to an interlace image. In addition, the field 22a is generated from the odd numbered lines of the frame 12 that comes after the frame 11, and the field 22b is generated from the even numbered lines of the frame 12.

As already discussed, each of the fields of the converted interlace image is an image that is shifted by one line from its adjacent fields in terms of space. In the conventional pulldown-sequence detecting method, the fields that are spatially shifted by one line are compared to find the variation pattern of the differences between the fields, and a pulldown sequence is detected on the basis of this pattern. For this reason, the result of the field comparison may include errors in relation to space, which lowers accuracy in detection.

On the contrary, in the pulldown-sequence detecting method according to the embodiment, comparison of frames is conducted in advance to the comparison of fields to reduce the influence of errors in relation to space. For instance, when the field 22a is to be compared with the preceding field 21b, before comparing those two fields, the comparison of the fields 22a and 21a is conducted first.

The field 22a is composed of the odd numbered lines of the frame 12, while the field 21a is composed of the odd numbered lines of the frame 11 preceding the frame 12. In other words, the fields 22a and 21a are images shifted by one frame in terms of timing but are the same in terms of space.

Hence, pixels in which some change occurs during a period of time corresponding to a single frame can be exclusively extracted without any error in relation to space by comparing the pixels of the field 22a with the pixels of the field 21a at the corresponding positions. If a difference is found between frames, it indicates that the photographed subject or the like has made a move during that period of time. Extraction of the pixels in which some change occurs during a period of time equivalent to one frame means extraction of pixels that have made a move during that period of time.

Then, by comparing only the motion involving portions of the fields 22a and 21a, the comparison can be conducted between adjacent fields, focusing on portions that may involve differences attributed to different timings but not on portions that would match without shifting in relation to space. This improves accuracy in detection of a pulldown sequence.

In the similar manner, when the field 22b and the preceding field 22a are to be compared, the field 22b and the field 21b of the preceding frame are compared beforehand. Then, the comparison between the fields 22b and 22b is conducted, focusing on the portions in which differences are found. The adjacent fields can be thereby compared, with less influence of errors in relation to space.

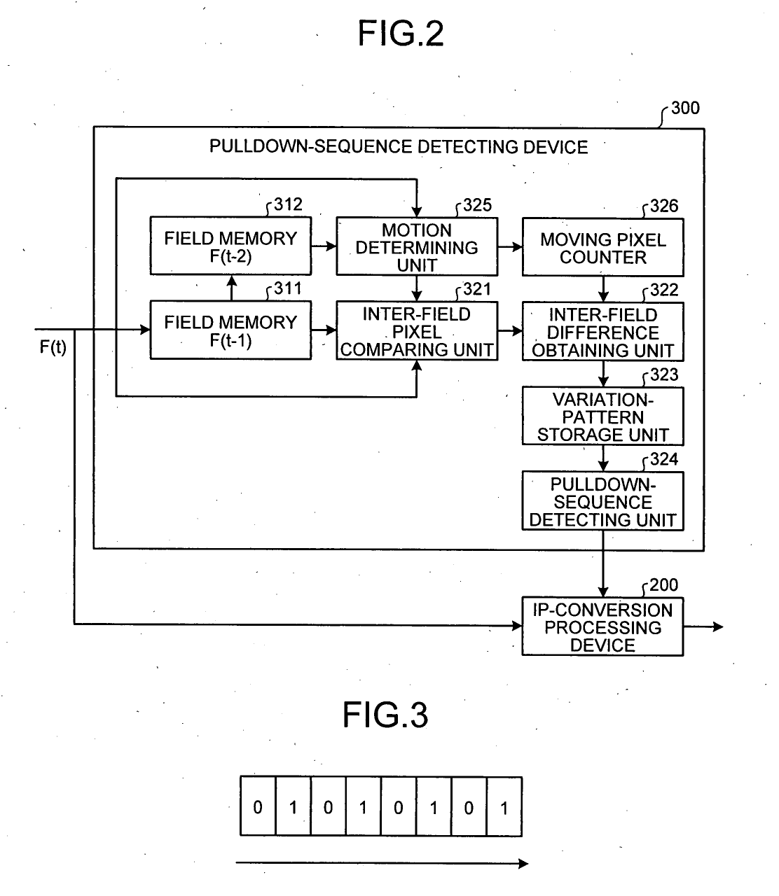

Next, a pulldown-sequence detecting device according to the embodiment will be explained. FIG. 2 is a functional block diagram of a pulldown-sequence detecting device 300 according to the embodiment. The pulldown-sequence detecting device 300 includes two field memories 311 and 312, an inter-field pixel comparing unit 321, an inter-field difference obtaining unit 322, a variation-pattern storage unit 323, a pulldown-sequence detecting unit 324, a motion determining unit 325, and a moving pixel counter 326.

The field memory 311 stores therein the image of the latest field in the record of an interlace image that is input into the pulldown-sequence detecting device 300. The field memory 312 stores therein the image of the field preceding the field stored in the field memory 311. In other words, if the image data currently input into the pulldown-sequence detecting device 300 is of the field F(t), the field memory 311 stores the data of the immediately preceding field F(t-1), while the field memory 312 stores the data of the further preceding field F(t-2).

The inter-field pixel comparing unit 321 compares the pixels of the field currently input into the pulldown-sequence detecting device 300 with the corresponding pixels of the preceding field stored in the field memory 311, and outputs the result of the comparison to the inter-field difference obtaining unit 322. The inter-field pixel comparing unit 321 extracts pixels that are determined as including some motion by the motion determining unit 325 out of the pixels included in the input image data, and compares them with the pixels at the corresponding positions that are stored in the field memory 311.

The comparison of pixels can include, for example, comparison of brightness values of the pixels. Moreover, the comparison of target pixels can be conducted in one to one basis, or can be conducted by considering values of pixels around the target pixels. In the following description, it is assumed that the inter-field pixel comparing unit 321 compares the brightness of the individual pixels at the same positions and outputs the differences in brightness to the inter-field difference obtaining unit 322.

The motion determining unit 325 compares the pixels of the field currently input into the pulldown-sequence detecting device 300 with two fields before that is stored in the field memory 312, which is the field composed of the same set of lines in the preceding frame. The motion determining unit 325 then determines pixels in which the difference is greater than a predetermined threshold, as pixels with motions, and notifies the inter-field pixel comparing unit 321 of the pixels determined as the pixels with motions. The motion determining unit 325 compares all the pixels included in the input image data with the pixels at the corresponding positions stored in the field memory 312. The comparison of pixels can include, for example, comparison of brightness values of the pixels.

In addition, when determining that there is some movement on the basis of a difference between frames, the motion determining unit 325 informs the moving pixel counter 326 of this and increments the value stored in the moving pixel counter 326 by 1. The moving pixel counter 326 is a counter that stores the number of pixels that are determined as having movement by the motion determining unit 325 (hereinafter, “number of moving pixels”) in the field currently input in the pulldown-sequence detecting device 300. The value of the moving pixel counter 326 is initialized to 0 (zero) every time a new field is input into the pulldown-sequence detecting device 300.

The inter-field difference obtaining unit 322 is a processing unit that obtains a difference between the features of the currently input field and the preceding field stored in the field memory 311, on the basis of the value input from the inter-field pixel comparing unit 321. The difference between the features of the fields may be obtained as a difference mean value by the following expression:

Difference mean value=SAD÷Number of moving pixels

The value SAD is obtained by compiling the absolute values of the differences between the brightness of the pixels within a single field that are input from the inter-field pixel comparing unit 321. This SAD varies in accordance not only with the levels of the differences between the fields but also with the number of pixels the motion determining unit 325 determines as having movement. Thus, in the above expression, the SAD is divided by the number of moving pixels to find the difference mean value for one moving pixel so that the differences between the features of the fields can be compared on an equitable basis.

The variation-pattern storage unit 323 stores therein the predetermined number of absolute values of the latest differences obtained by the inter-field difference obtaining unit 322. The values stored in the variation-pattern storage unit 323 may be the values obtained by the inter-field difference obtaining unit 322 as they are, or values that indicate the comparative relation of the values obtained by the inter-field difference obtaining unit 322 with a predetermined threshold.

An example of the structure of the data stored in the variation-pattern storage unit 323 is shown in FIG. 3. FIG. 3 is a diagram for explaining an example in which a value obtained by the inter-field difference obtaining unit 322 is compared with a predetermined threshold. When the threshold is smaller, “1” is stored, whereas when the threshold is larger, “0” is stored. In this example, the variation of the inter-field feature differences for the last eight fields is stored.

The pulldown-sequence detecting unit 324 monitors the variation pattern of the values stored in the variation-pattern storage unit 323. When a certain variation pattern appears, the pulldown-sequence detecting unit 324 informs the IP-conversion processing device 200 that a pulldown sequence has been detected.

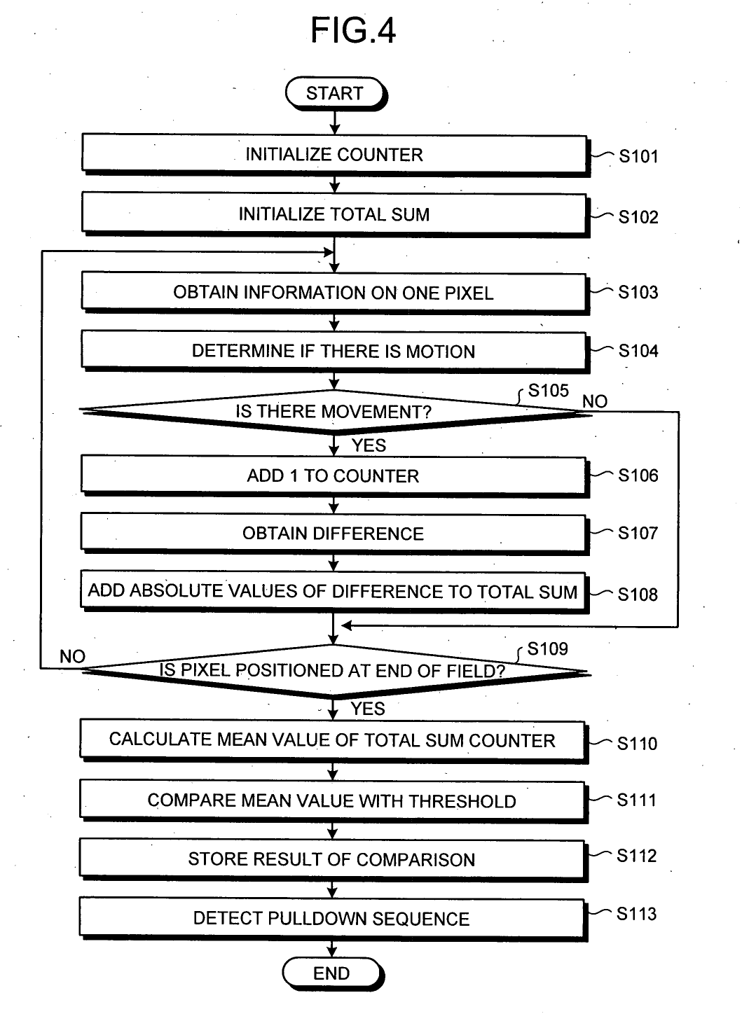

Next, the processing procedure performed by the pulldown-sequence detecting device 300 illustrated in FIG. 2 is explained. FIG. 4 is a flowchart for explaining a processing procedure of the pulldown-sequence detecting device 300. The processing procedure indicated in this drawing is executed every time a new field is input into the pulldown-sequence detecting device 300.

When a new field is input, the moving pixel counter 326 initializes a counter that indicates the number of moving pixels stored therein (step S101). The inter-field difference obtaining unit 322 initializes a total sum that indicates the total sum of the difference absolute values stored therein (step S102).

The motion determining unit 325 obtains information on one pixel (step S103), compares it with the pixel of the field of the preceding frame stored in the field memory 312 that is located at the corresponding position, and determines whether there is any movement (step S104). If it is determined that there is movement (Yes at step S105), the moving pixel counter 326 adds 1 to the counter (step S106). The inter-field pixel comparing unit 321 compares the pixel that is determined as having movement with the pixel that is located in the corresponding position of the preceding field stored in the field memory 311, and obtains a difference (step S107). The inter-field difference obtaining unit 322 adds the absolute value of this difference to the total sum (step S108).

After the processing of the pixel is completed and if the processed pixel is not positioned at the end of a field (No at step S109), the system control goes back to step S103 to carry out the processing on the next pixel. If the processed pixel is positioned at the end of a field (Yes at step S109), the inter-field difference obtaining unit 322 calculates the mean value of the total sum by dividing the total sum by the counter (step S110). The mean value is compared with the predetermined threshold (step S111), and stores the result of the comparison in the variation-pattern storage unit 323 (step S112).

The pulldown-sequence detecting unit 324 conducts pulldown sequence detection in accordance with the variation pattern of the absolute values of the inter-field differences stored in the variation-pattern storage unit 323 (step S113).

The structure of the pulldown-sequence detecting device 300 can be modified in various manners without departing from the scope of the present invention. For instance, the field memories 311 and 312 may be integrated into a single unit. Furthermore, the pulldown-sequence detecting device 300 and the IP-conversion processing device 200 can be integrated into a single unit.

In addition, the functions of the pulldown-sequence detecting device 300 can be implemented with software and executed by a computer to realize functions comparable to the pulldown-sequence detecting device 300. An example of a computer that executes a pulldown-sequence detecting program 1071 implemented as software to realize the functions of the pulldown-sequence detecting device 300 is described below.

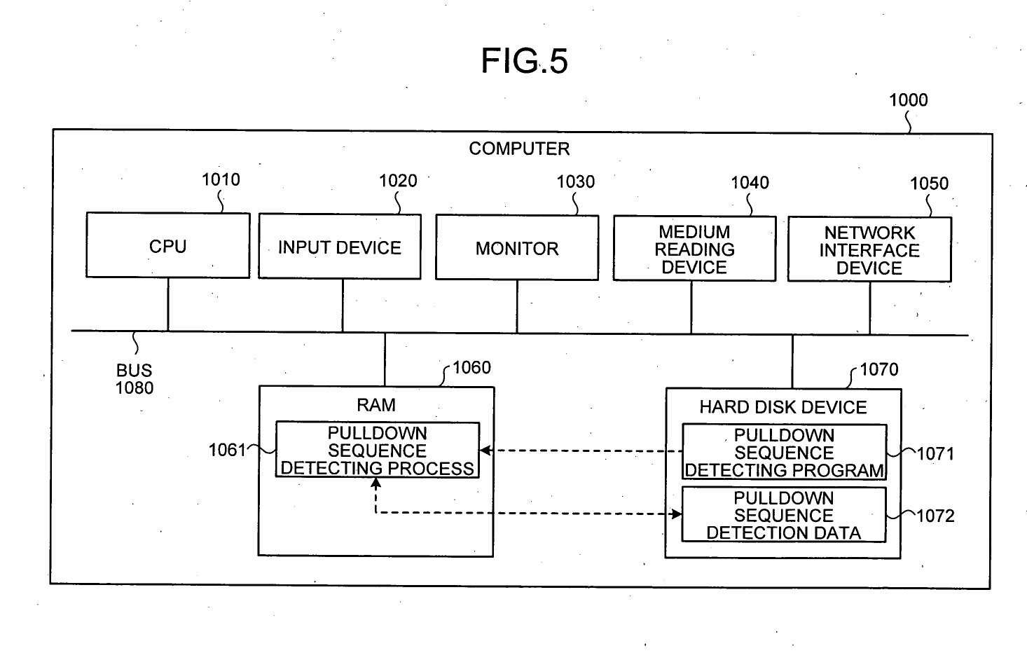

FIG. 5 is a functional block diagram of a computer 1000 that executes the pulldown-sequence detecting program 1071. The computer 1000 includes a central processing unit (CPU) 1010 that executes various calculating processes, an input device 1020 that receives data input from a user, a monitor 1030 that displays various kinds of information, a medium reading device 1040 that reads a program or the like from a recording medium that stores various programs, a network interface device 1050 that exchanges data with other computers via a network, a random access memory (RAM) 1060 that temporarily stores various kinds of information, and a hard disk device 1070, all components connected to one another by a bus 1080.

The hard disk device 1070 stores therein the pulldown-sequence detecting program 1071 that has similar functions to the processing units of the pulldown-sequence detecting device 300 illustrated in FIG. 2, and pulldown sequence detection data 1072 that corresponds to various kinds of data stored in the variation-pattern storage unit 323 and the like of the pulldown-sequence detecting device 300 illustrated in FIG. 2. The pulldown sequence detection data 1072 can be distributed and stored in other computers connected via a network.

The CPU 1010 retrieves the pulldown-sequence detecting program 1071 from the hard disk device 1070 to load into the RAM 1060. The pulldown-sequence detecting program 1071 thereby comes to serve as a pulldown-sequence detecting process 1061. The pulldown-sequence detecting process 1061 loads the information or the like that is read out among the pulldown sequence detection data 1072, suitably into the assigned region of the RAM 1060. Various data processes are executed on the basis of this loaded data.

The pulldown-sequence detecting program 1071 does not always have to be stored in the hard disk device 1070. The program may be stored in a recording medium such as a CD-ROM, and may be retrieved and executed by the computer 1000. Otherwise, the program may be stored in a different computer (or a server) connected to the computer 1000 via a public line, the Internet, a local area network (LAN), or a wide area network (WAN) so that the computer 1000 can retrieve and execute the program therefrom.

According to the embodiment, frames are compared in advance to comparison of adjacent fields so that only moving portions of the fields can be compared. Hence, the influence of errors in relation to space is reduced, and the accuracy in detecting a pulldown sequence is improved.

According to one aspect of the present invention, comparison is performed between frames in advance of comparison between adjacent fields so that the field comparison is performed only on portions that include some motion. This reduces influence of errors in relation to space and improves accuracy in pulldown sequence detection.

According to another aspect of the present invention, features of pixels at the same positions are compared, and if a difference between the features is greater than a threshold, it is determined as including some motion. Thus, the present invention can readily determine whether there is any motion.

According to still another aspect of the present invention, the mean value of the absolute values of the differences between the fields represents the difference in the features. As a result, even if the numbers of pixels that are determined as having some motion vary among different fields, such variation does not influence the variation pattern of the differences of the features.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A pulldown-sequence detecting device that detects a pulldown sequence from an interlace image, the pulldown-sequence detecting device comprising:
a determining unit that compares a first field included in the interlace image with a third field of an immediately preceding frame and thereby performs motion determination on every pixel;
a calculating unit that calculates an absolute value of a difference between features by using a portion of the first field that is determined by the determining unit as having movement and peripheral pixels of a second field that is a field immediately preceding the first field; and
a detecting unit that detects a pulldown sequence in accordance with a variation pattern of the absolute value of the difference between the features of the fields calculated by the calculating unit.

2. The pulldown-sequence detecting device according to claim 1, wherein the determining unit calculates a difference between features of pixels of the first field and pixels of the third field located at corresponding positions, and determines that the pixels of the first field have movement when the difference is greater than a predetermined threshold.

3. The pulldown-sequence detecting device according to claim 1, wherein the calculating unit compiles absolute values of differences between the features of the pixels of the first field that are determined by the motion determining unit as having movement and the pixels of the second field located in the corresponding positions, and calculates a mean value of the differences by dividing compiled absolute values by the number of pixels of the first field determined by the determining unit as having movement.

4. The pulldown-sequence detecting device according to claim 1, wherein the detecting unit detects a 2:2 pulldown sequence when the variation pattern exhibits a repetitive low-high-low-high pattern.

5. The pulldown-sequence detecting device according to claim 2, wherein the feature of the pixel includes brightness value of the pixel.

6. The pulldown-sequence detecting device according to claim 3, wherein the feature of the pixel includes brightness value of the pixel.

7. A method of detecting a pulldown sequence from an interlace image, the method comprising:
determining whether there is motion in each pixel by comparing a first field included in the interlace image with a third field of an immediately preceding frame;
calculating an absolute value of a difference between features by using a portion of the first field that is determined at the determining as having movement and peripheral pixels of a second field that is a field immediately preceding the first field; and
detecting a pulldown sequence in accordance with a variation pattern of the absolute value of the difference between the features of the fields that are calculated at the calculating.

8. The method according to claim 7, wherein the determining includes calculating a difference between features of pixels of the first field and pixels of the third field located at corresponding positions, and determining that the pixels of the first field have movement when the difference is greater than a predetermined threshold.

9. The method according to claim 7, wherein the calculating includes compiling absolute values of differences between the features of the pixels of the first field that are determined at the determining as having movement and the pixels of the second field located in the corresponding positions, and calculating a mean value of the differences by dividing compiled absolute values by the number of pixels of the first field determined at the determining as having movement.

10. The method according to claim 7, wherein the detecting includes detecting a 2:2 pulldown sequence when the variation pattern exhibits a repetitive low-high-low-high pattern.

11. The method according to claim 8, wherein the feature of the pixel includes brightness value of the pixel.

12. The method according to claim 9, wherein the feature of the pixel includes brightness value of the pixel.

13. A computer-readable recording medium that stores therein a computer program that causes a computer to detect a pulldown sequence from an interlace image, the computer program causing the computer to execute:
determining whether there is motion in each pixel by comparing a first field included in the interlace image with a third field of an immediately preceding frame;
calculating an absolute value of a difference between features by using a portion of the first field that is determined at the determining as having movement and peripheral pixels of a second field that is a field immediately preceding the first field; and
detecting a pulldown sequence in accordance with a variation pattern of the absolute value of the difference between the features of the fields that are calculated at the calculating.

14. The computer-readable recording medium according to claim 13, wherein the determining includes calculating a difference between features of pixels of the first field and pixels of the third field located at corresponding positions, and determining that the pixels of the first field have movement when the difference is greater than a predetermined threshold.

15. The computer-readable recording medium according to claim 13, wherein the calculating includes compiling absolute values of differences between the features of the pixels of the first field that are determined at the determining as having movement and the pixels of the second field located in the corresponding positions, and calculating a mean value of the differences by dividing compiled absolute values by the number of pixels of the first field determined at the determining as having movement.

16. The computer-readable recording medium according to claim 13, wherein the detecting includes detecting a 2:2 pulldown sequence when the variation pattern exhibits a repetitive low-high-low-high pattern.

17. The computer-readable recording medium according to claim 14, wherein the feature of the pixel includes brightness value of the pixel.

18. The computer-readable recording medium according to claim 15, wherein the feature of the pixel includes brightness value of the pixel.
